(19) United States
(12) Patent Application Publication
(10) Pub. No.: US 2009/0310330 A1
(43) Pub. Date: Dec. 17, 2009

(54) Combination Luminaire and Path of Egress Lighting

(75) Inventors: Steen Vann, Morrow, GA (US); Patrick Neal Walker, Peachtree City, GA (US)

Correspondence Address: KING & SPALDING, 1180 PEACHTREE STREET , NE, ATLANTA, GA, 30309-3521, US

(73) Assignee: Cooper Technologies Company, Houston, TX (US)

(21) Appl. No.: 12/138,934

(22) Filed: Jun. 13, 2008

(51) Int. Cl. F21V 19/04; F21V 23/04; H05B 37/00

(52) U.S. Cl. 362/20; 315/86; 362/249.02

(57) ABSTRACT

A combination luminaire and path of egress lighting includes a lamp housing and one or more auxiliary lamps. The lamp housing includes an electrical enclosure, a lamp mounting area and a lamp cover. A primary light source is positioned within and coupled to the lamp housing. The auxiliary lamps are coupled to and extend out from the exterior of the lamp housing. Each auxiliary lamp typically include a base plate, a stem member, and a task lamp housing. The base plate is coupled to the exterior of the lamp housing. The stem rotatably coupled on one end to the base plate and along the other end to the task lamp housing. By rotatably coupling auxiliary lamp along each end of the stem member, the task lamp housing has a large range of adjustability so that it can be aimed towards paths of egress after the luminaire is installed.

### FIELD OF THE INVENTION

This invention relates generally to lighting systems for parking garage facilities. More particularly, the invention relates to an auxiliary lighting system positioned along the exterior of individual parking garage luminaires.

### BACKGROUND

A luminaire is a system for producing, controlling, and/or distributing light for illumination. For example, a luminaire can include a system that outputs or distributes light into an environment, thereby allowing certain items in that environment to be visible. Luminaires are sometimes referred to as “light fixtures”.

Many conventional parking garage luminaires use a high-intensity discharge (HID) lamp as their primary light source. One problem with the HID lamp is that it will extinguish when power to the luminaire is interrupted. Momentary power interruptions, such as a lightning strike or someone power spike, will cause the HID lamp to extinguish. An extinguished HID lamp will not immediately re-ignite upon the restoration of power to the luminaire, because gases within the HID lamp must be cooled before the HID lamp will re-ignite. With the power restored, restarting a hot HID lamp can take several minutes. Even when they are cool and easy to start, HID lamps still take up to 2 minutes to come to full bright after they are ignited. Similar problems can occur when the primary light source is a pulse-start metal halide lamp, a high pressure sodium lamp, or a compact fluorescent lamp (“CFL”).

The garage building industry puts a great deal of time and effort in designing its emergency lighting standards. The industry likes to see a certain minimum amount of light along paths of egress in their structures during power interruptions. Accordingly, auxiliary lighting control circuitry has been used for automatically lighting an auxiliary light source, such as an incandescent lamp, following a brief power interruption of a HID lamp. Round and square garage lights having a primary light source and an auxiliary lamp positioned within the luminaire have been used for many years. The premise is that when the primary lamp, located at the center of the fixture, is not on the auxiliary lamp, which is typically a smaller cylindrical incandescent lamp mounted to the side of the primary lamp, is lit to provide emergency illumination. However, there are inherent problems with these current practices of providing auxiliary light to garage lighting systems.

During normal operation, the auxiliary lamp mounted on one side of the fixture blocks or refracts light from the primary lamp located at the center of the fixture. This causes the auxiliary lamp, during normal operation of the primary lamp, to form a shadow on the area being lit. Other conventional fixtures have solved the shadowing problem by replacing the interior incandescent fixture with an auxiliary circular fluorescent fixture above the light emitting portion of the primary lamp. By placing the auxiliary circular fluorescent fixture above the light emitting portion of the primary lamp, the fluorescent fixture does not cause shadowing. However, by continuing to place the auxiliary fluorescent fixture within the interior of the luminaire the spread of light from the auxiliary fluorescent fixture is restricted to the same area as that of the HID lamp and cannot be directed towards specific areas of egress that would be helpful to patrons within the garage facility during a power outage.

Accordingly, what is needed in the art is a garage luminaire with auxiliary emergency lighting that is capable of being aimed at paths of egress independent of the light spread capable from the luminaire.

### SUMMARY OF THE INVENTION

The combination luminaire and path of egress lighting provides a garage light with improved emergency lighting that includes the ability to rotate the emergency lighting in the x and y planes and gives better directional accuracy for the emergency lighting. Further, by positioning the emergency lighting along the exterior of the housing of the garage light, the emergency lighting does not interfere with or reduce the efficiency of the primary light source within the light housing.

For one aspect of the present invention, the novel luminaire can include a luminaire housing. The luminaire can further include a first lamp positioned within the luminaire housing. The luminaire can also include one or more second lamps coupled to and extending out from the exterior of the luminaire housing.

For another aspect of the present invention, a garage luminaire with emergency path of egress lighting can include a luminaire housing. The luminaire housing can have an interior and an exterior. The interior of the luminaire housing can include a lamp mounting area and a lamp cover. All or a part of a first lamp can be positioned between the lamp mounting area and the lamp cover of the luminaire housing. One or more second lamps can be coupled to and extend out from the exterior of the luminaire housing. In certain exemplary embodiments, the first lamp is different from the second lamp. For example, the first lamp can be a HID lamp and the second lamp can be an MR-16 lamp. The luminaire can further include a switching circuit. The switching circuit can control the application of a voltage source to the second lamp when power to the first lamp is interrupted.

For yet another aspect of the present invention, a garage luminaire with supplemental path of egress lighting can include a luminaire housing that has an interior and an exterior. The luminaire can also include a first lamp coupled to the interior of the luminaire housing. The first lamp is typically the primary light source. Multiple second lamps can be coupled to and extend out from the exterior of the luminaire housing. The second lamps are typically path of egress light sources. The luminaire can further include a switching circuit that controls the illumination of the second lamps when power to the first lamp is interrupted. A supplemental power source can be electrically coupled to the second lamps to provide electrical power to the second lamps when power to the first lamp is interrupted.

These and other aspects, features, and embodiments of the invention will become apparent to a person of ordinary skill in the art upon consideration of the following detailed description of illustrated embodiments exemplifying the best mode for carrying out the invention as presently perceived.

### BRIEF DESCRIPTION OF THE DRAWINGS

For a more complete understanding of the exemplary embodiments of the present invention and the advantages thereof, reference is now made to the following description in conjunction with the accompanying drawings in which:

FIG. 1 is a perspective view of a luminaire with exterior auxiliary lamps according to one exemplary embodiment of the present invention;

FIG. 2 is a perspective view of the auxiliary lamp of FIG. 1 in accordance with one exemplary embodiment of the present invention;

FIG. 3 is a perspective view of the luminaire of FIG. 1 with two exterior auxiliary lamps in accordance with one exemplary embodiment of the present invention;

FIG. 4 is a perspective view of the luminaire of FIG. 1 with three exterior auxiliary lamps according to one exemplary embodiment of the present invention;

FIG. 5 is a perspective view of the luminaire of FIG. 1 with four exterior auxiliary lamps in accordance with one exemplary embodiment of the present invention;

FIG. 6 is a perspective view of the luminaire of FIG. 1 with an alternative exterior auxiliary lamp in accordance with another exemplary embodiment of the present invention; and

FIG. 7 is a perspective view of the luminaire of FIG. 1 with another alternative exterior auxiliary lamp in accordance with yet another exemplary embodiment of the present invention.

### DETAILED DESCRIPTION OF THE EXEMPLARY EMBODIMENTS

The present invention is directed to a luminaire used in parking garages and other areas where there is a need for back-up, or auxiliary, lighting to show a path of egress when the primary lamp in the luminaire is off, burned out, or in the process of restarting. The inventive functionality of the luminaire with exterior lamps for path of egress lighting will be explained in more detail in the following description and is disclosed in conjunction with the presented figures.

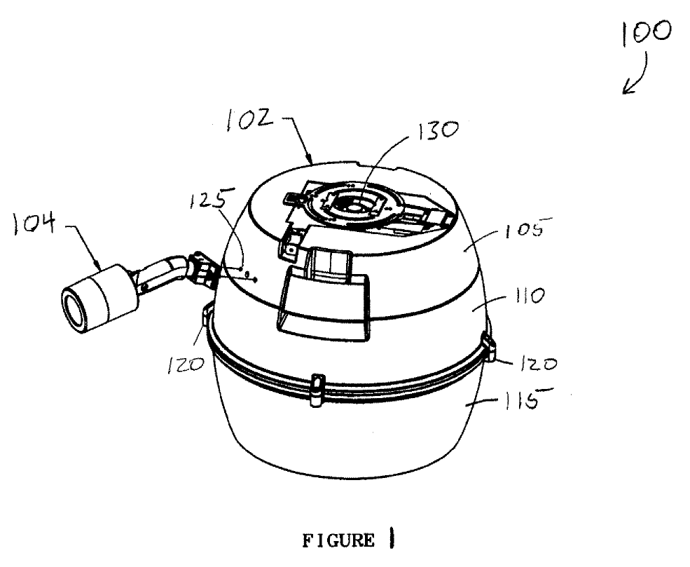

Referring now to the drawings in which like numerals represent like elements throughout the several figures, aspects of the present invention will be described. FIGS. 1-5 show perspective views of the garage luminaire 100 according to one exemplary embodiment of the present invention. Now referring to FIGS. 1-5, the exemplary garage luminaire 100 includes a lamp housing 102 and one or more auxiliary lamps 104 coupled to the exterior of the lamp housing 102. The lamp housing 102 includes an electrical enclosure 105, a lamp mounting area 110, and a lamp cover 115. While the overall shape of the lamp housing 102 is shown as circular in the exemplary embodiment, those of ordinary skill in the are will recognize that the housing can take many other shapes including, but not limited to, square, rectangular, oval and other geometric and non-geometric, or irregular, shapes.

The electrical enclosure 105 includes wiring, ballasts, an auxiliary light switch, and any other electrical equipment that may be associated with the primary lamp (not shown) and auxiliary lamp 104. In one exemplary embodiment, the auxiliary light switch is a switching circuit that controls the application of the voltage source to the auxiliary lamp when there is an interruption of power supplied to the primary lamp. In one exemplary embodiment, the electrical enclosure 105 also includes a battery or other self contained power source (not shown) for providing power to the auxiliary lamp 104.

In an alternative embodiment, the auxiliary lamp 104 is electrically coupled to a primary power source (not shown) and the battery. In this embodiment, the auxiliary lamp 104 will typically only draw power from the battery if the primary power source is not supplying electrical power. For example, when a power outage occurs, the auxiliary lamp 104 draws power from the battery to light a path of egress while the primary lamp is off. Once power is restored through the primary power source, it may still take several minutes for the primary lamp to restart. During that period, the auxiliary lamp 104 continues to operate and light a path of egress, however, the auxiliary lamp can draw its power during this period either from the battery or the primary power source.

In yet another exemplary embodiment, the exemplary system includes an external emergency power supply system that is electrically coupled to the auxiliary lamp 104. The external emergency power supply system is located remotely from the luminaire 100 and supplies power to the auxiliary lamp 104 when there is a power supply disruption to the primary lamp. Power is typically provided to the electrical enclosure 105 by way of conventional power transmission means through the lamp fastener assembly 130.

The lamp mounting area 110 is coupled to, or can be integral with, the electrical enclosure 105. On a bottom facing side of the lamp mounting area 110 is a lamp mounting surface (not shown). In one exemplary embodiment, the lamp mounting surface is round and covers most of the lower portion of the lamp mounting area 110. Further, in this exemplary embodiment, the lamp mounting surface has an anodized reflective surface for reflecting the light supplied by the primary lamp (not shown) to the desired areas. In an alternative exemplary embodiment, the lamp mounting area 110 includes a bottom surface (not shown) to which a reflective lamp mounting surface is coupled by known coupling methods including, but not limited to adhesives, welding, screws, other fasteners, and the like. The lamp mounting area 110 further includes a lamp socket (not shown) or other connection means known in the art for connecting the primary lamp to the primary power source in the electrical enclosure 105. The lamp socket is typically coupled to the lamp mounting area 110 and electrically coupled to the primary power source in the electrical enclosure 105.

In one exemplary embodiment, the primary lamp is a HID lamp that is mounted into a HID lamp socket. The HID lamp socket is centrally located within the lamp mounting surface along the bottom side of the lamp mounting area 110. In alternative embodiments, the primary lamp is a pulse start metal halide, a high pressure sodium lamp, an electrodeless fluorescent lamp or a compact fluorescent lamp. In each of these alternative embodiments, the lamp socket or electrical attachment for the primary lamp includes the conventional electrical attachments for each of these types of lamps that are well-known in the art. Further, while the exemplary embodiment teaches a single primary lamp positioned within the lamp housing 102, two or more primary lamps can be coupled within the lamp housing 102 within the scope of this invention. The primary lamp projects its light downwardly and radially with the aid of the lamp mounting surface along the bottom of the lamp mounting area 110.

The lamp cover 115 can take the form of several different embodiments based on the particular application of the luminaire 100 and the primary lamp within the lamp housing 102. In one exemplary embodiment, the luminaire 100 of the present invention includes the lamp cover 115. The lamp cover 115 has prisms (not shown) on an inner surface forming a lens. These prisms are vertically extending ridges having sides at about 45 degrees toward the optical center of the luminaire 100. In another exemplary embodiment (not shown) the ridge sides vary in angle toward the optical center of the luminaire so that light is focused toward alternative areas. These prisms spread the light laterally, causing all or a portion of the lamp cover 115 to glow and reduce the glare that is associated with the luminaire 100. The lamp cover 115 can also include a lower smooth surface below the prismatic area. In this embodiment, the bottom side of the lamp cover 115 is typically transparent; however, it can also be diffusive or include diffusive material on all or a portion of the bottom side of the lamp cover 115.

In an alternative embodiment, the lamp cover 115 includes prismatic surfaces on the exterior and/or interior side of the cover 115 to direct light emitted from the primary lamp and the reflective surface on the bottom of the lamp mounting area 110. The prismatic surfaces on the alternative lamp cover 115 typically cause the lamp cover 115 to glow and direct the light to desired areas. The prismatic surfaces or lens can be vertical, horizontal, rounded, square, or any other configuration or shape as desired to refract the light being emitted from the primary lamp and the reflective surface to the desired locations. As with the exemplary embodiment above, the bottom side of the lamp cover 115 is typically transparent; however, it can also be diffusive or include diffusive material on all or a portion of the bottom side of the lamp cover 115. The lamp cover 115 can be releasably or hingedly coupled to the lamp mounting area 110 by way of one or more coupling members 120. While not shown, a hinge can be coupled between the lamp mounting area 110 and the lamp cover 115 in conjunction with the coupling members 120 to allow the cover 115 to rotate from a closed configuration to an open configuration when the coupling members 120 are released or screws (not shown) are removed from the coupling members 120.

The exterior of the lamp housing 102 includes one or more sets of fastening apertures 125. The fastening apertures are configured to received a screw or other fastening device for coupling the auxiliary lamp 104 to the exterior of the lamp housing 102. In one exemplary embodiment, the fastening device is a #10-24 phillips pan-head screw. While the fastening apertures 125 are shown in the exemplary embodiment as being positioned along the exterior of the electrical enclosure 105, the fastening apertures 125 can alternatively be positioned along the exterior of the lamp mounting area 110 or any combination of both the electrical enclosure 105 and the lamp mounting area 110.

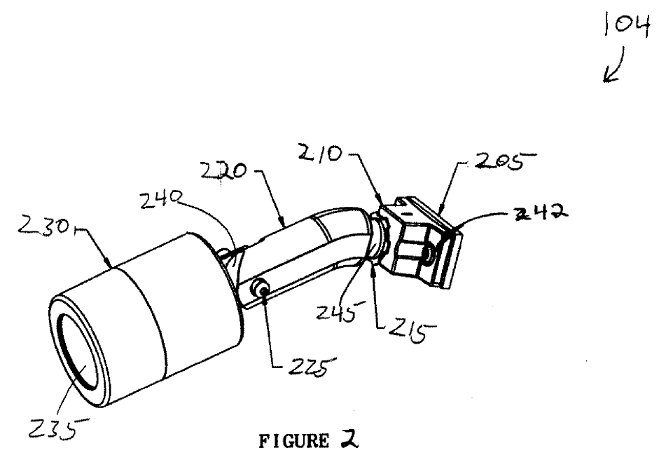

As best shown in FIG. 2, the auxiliary lamp 104 includes a mounting base 210. The mounting base 210 includes one or more apertures 242 that are configured to receive a screw or other fastening device for coupling the auxiliary lamp 104 to the exterior of the lamp housing 102. As discussed above, in one exemplary embodiment, the fastening device is a #10-24 phillips pan-head screw. When the mounting base 210 is coupled to the lamp housing 102, through the fastening apertures 125, a gasket 205 is positioned between the lamp housing 102 and the mounting base 210 to provide a seal therebetween and to limit the amount of thermal energy that escapes the lamp housing 102 through the fastening apertures 125.

A stem 220 is rotatably coupled along one end by way of a threaded shaft 245 to the mounting base 210. The stem 220 typically includes a longitudinal member with discreet ends in which one end includes the threaded shaft 245 and the other end includes a rotatable joint 240. The stem 220 can be straight, curvilinear, or have discreet angled portions. In addition, the stem 220 can be made up of one or multiple members coupled together in a fixed or rotational relationship. In one exemplary embodiment, the stem 220 is hollow or includes a channel therethrough, wherein electrical wires are run from the electrical enclosure 105 to an auxiliary lamp in the task light head 230. In one exemplary embodiment, the stem 220 rotates 360 degrees about its threaded shaft 245. In this embodiment, the direction of the stem 220 is selected by rotating the threaded shaft 245 in the mounting base 210. The stem 220 is then held in place in the selected direction by tightening a lock nut 215 on the threaded shaft 245 to the mounting base 210.

The auxiliary lamp 104 further includes the joint 240 rotatably coupled on one end to the stem 220 and on the other end to the task light head 230. The joint 240 provides the task light head 230 with at least 270 degrees of rotation along the X and Y planes. Once the direction of the task light head 230 is selected by rotation of the joint 240, the movement of the joint can be restricted by tightening the screw 225. In one exemplary embodiment, the screw 225 is a #10-24 allen-head screw.

The auxiliary lamp 104 further includes the task lamp head 230. The task lamp head houses a task light (not shown) that provides the illumination that is emitted from the auxiliary lamp 104. In one exemplary embodiment, the task lamp head 230 has a substantially cylindrical shape, with one end coupled to the joint 240. Light is emitted from the other end of the task lamp head 230 by way of the task light. The task lamp head 230 further includes a task lamp socket (not shown). In one exemplary embodiment, the task light is an MR-16 lamp and the task lamp socket is an MR-16 lamp socket. In an alternative embodiment, the task light is any emergency rated lamp source. In addition, the task lamp head 230 can include a reflective surface disposed about all or a portion of the task light and the task lamp socket. The light emitted by the task light and/or reflected by the reflective surfaces passes through the task light cover 235. In one exemplary embodiment, the task light cover 235 is transparent. However, the task light cover 235 can also be diffusive or include a lens to focus or spread the light passing therethrough a given direction.

In operation, once the auxiliary lamp 104 is coupled to the lamp housing 102, the stem 220 is rotated clockwise or counter-clockwise about the mounting base 210 until the stem 220 is in the preferred position, for example, to illuminate a path of egress. Once in the preferred position, the lock nut 215 is tightened to prevent further rotation of the stem 220. The task light head 230 is then aimed by rotating the head 230 about the stem 220 by way of the joint 240. Once the task light head 230 is in the preferred position, the screw 225 is tightened to prevent further movement of the task light head 230.

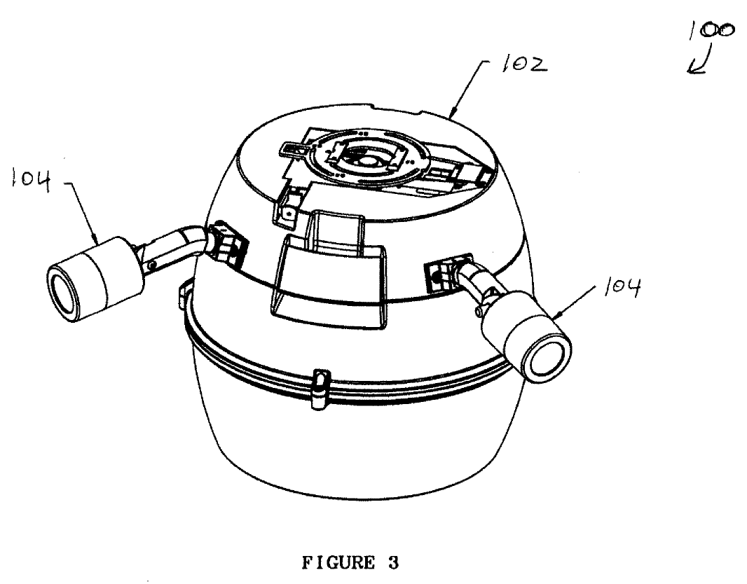

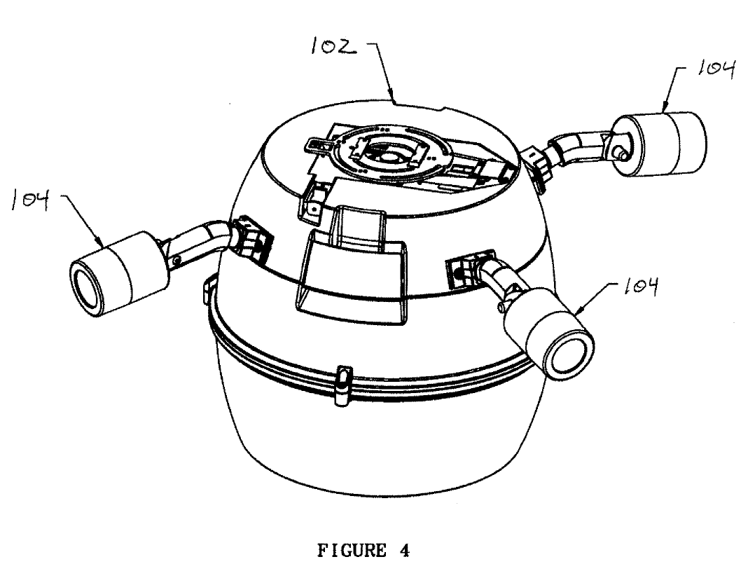

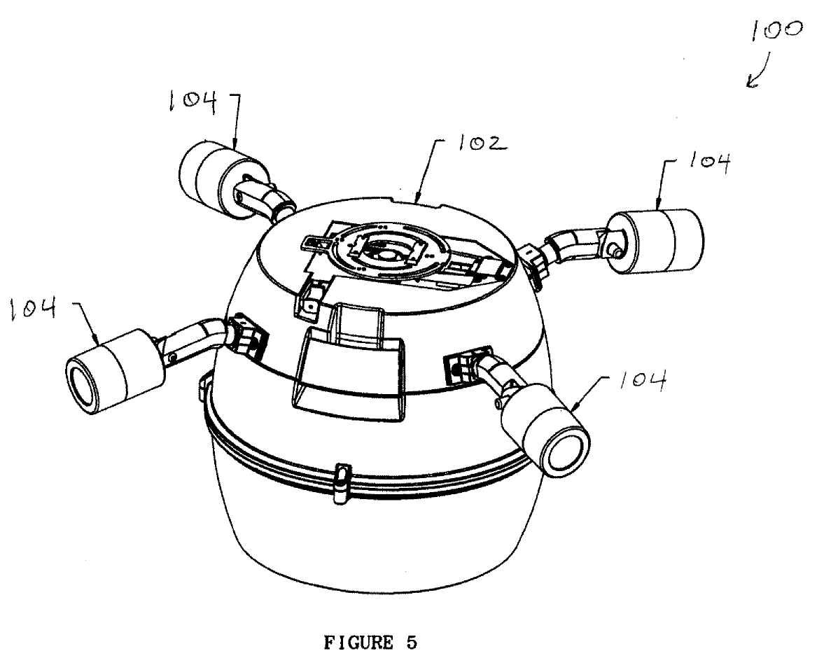

As shown in FIGS. 1 and 3-5, the exemplary luminaire 100 can include one or many auxiliary lamps 104. FIG. 3 presents an exemplary luminaire 100 with two auxiliary lamps 104 that are offset approximately ninety degrees from one another about the perimeter of the lamp housing 102. FIG. 4 presents an exemplary luminaire 100 with three auxiliary lamps 104 that are offset approximately ninety degrees from one another about the perimeter of the lamp housing 102. FIGS. 5 presents an exemplary luminaire 100 with four auxiliary lamps 104 that are offset approximately ninety degrees from one another. Those skilled in the art will recognize that more than four auxiliary lamps 104 can be positioned along the exterior of the lamp housing 102 as needed for the particular application. In addition, while the exemplary embodiments present the auxiliary lamps 104 offset by ninety degrees from one another, it is within the scope of this invention to offset each auxiliary lamp at any point between 0-180 degrees from one another about the perimeter of the exemplary lamp housing 102. Further, in alternative embodiments in which the lamp housing 102 has a non-circular shape, the auxiliary lamps 104 can be positioned anywhere along the exterior of the lamp housing 102 with respect to any other auxiliary lamp.

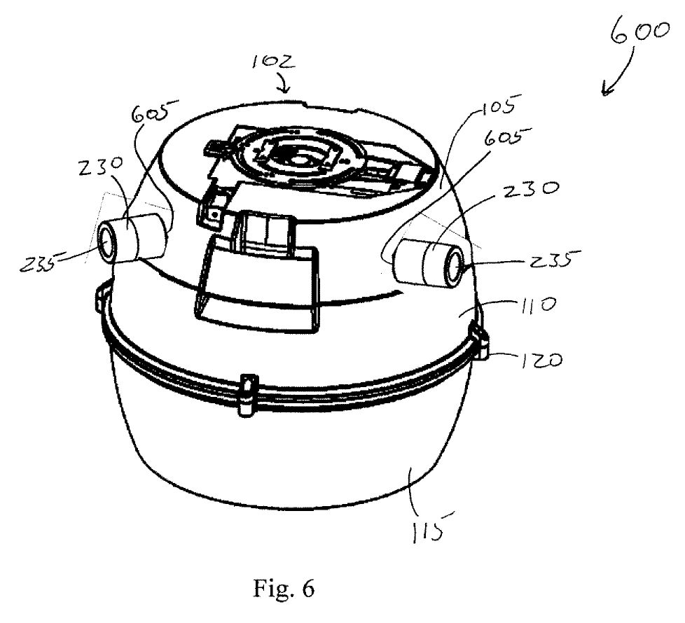

FIG. 6 is a perspective view of an alternative auxiliary lamp configuration used in conjunction with the lamp housing of FIG. 1, according to an alternative exemplary embodiment of the present invention. Turning now to FIG. 6, the alternative luminaire 600 includes the lamp housing 102. The lamp housing 102 is substantially as described above, except that the fastening apertures 125 are not included in the current embodiment. One or more task lamp heads 230 is rotatably coupled to a corresponding aperture 605 along the exterior of the lamp housing 102. In one exemplary embodiment, each task lamp head 230 is rotatably coupled to its aperture 605 by way of a joint (not shown). The joint can be substantially similar to the joint 240 described with reference to FIG. 2. In addition the task lamp head 230 is substantially as described with regard to FIGS. 1-5 and includes the task light (not shown), the task light socket (not shown), and the task light cover 235. As with the task light cover 235 described above, the task light cover 235 of FIG. 6 can be transparent, diffuse, or it can include a lens to focus or spread the light from the task light in a desired direction.

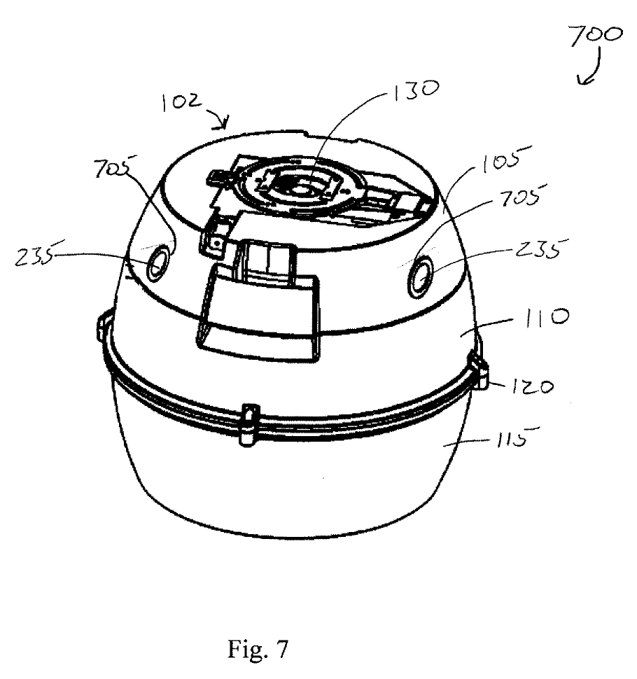

FIG. 7 is a perspective view of another alternative auxiliary lamp configuration used in conjunction with the lamp housing 102 of FIG. 1, according to an alternative exemplary embodiment of the present invention. Turning now to FIG. 7, the alternative luminaire 700 includes the lamp housing 102. The lamp housing 102 is substantially as described above, except that the fastening apertures 125 are not included in the luminaire 700. One or more task light covers 235 is rotatably coupled to corresponding apertures 705 along the exterior of the lamp housing 102. While not shown, the task light and the task light socket are typically coupled to the task light cover 235, such that movement of the task light cover 235 causes a corresponding rotation to the task light and task light socket. In one exemplary embodiment, each task light cover 235 is rotatably coupled to the aperture 705 by way of a joint (not shown). The joint can be substantially similar to the joint 240 described with reference to FIG. 2. In addition a task lamp head can be included along the interior of the lamp housing and is substantially as described with regard to FIGS. 1-5. As with the task light cover 235, described above, the task light cover 235 of FIG. 7 can be transparent, diffuse, or it can include a lens to focus or spread the light from a task light in a desired direction.

Although specific embodiments of the invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by a person of ordinary skill in the art, having the benefit of this disclosure, without departing from the spirit and scope of the invention defined in the following claims, the scope of which is to be accorded the broadest interpretation so as to encompass such modifications and equivalent structures.

What is claimed is:

1. A luminaire comprising:
a luminaire housing comprising an interior and an exterior;
a first lamp disposed within the interior of the luminaire housing; and
at least one second lamp coupled to and extending out from the exterior of the luminaire housing.

2. The luminaire of claim 1, wherein the luminaire housing comprises:
an electrical enclosure comprising electrical components electrically coupled to the first and second lamp;
a lamp mounting area comprising a lamp socket for electrically coupling the first lamp to at least one of the electrical components; and
a lamp cover, wherein at least a portion of the first lamp is disposed between the lamp mounting area and the lamp cover.

3. The luminaire of claim 2, wherein at least a portion of the lamp mounting area is reflective.

4. The luminaire of claim 2, wherein the lamp cover comprises prisms.

5. The luminaire of claim 1, wherein the second lamp comprises:
a base portion coupled to the luminaire housing;
a task lamp housing; and
a stem member comprising a first end and a second end, wherein the first end is rotatably coupled to the base portion and the second end is rotatably coupled to the task lamp housing.

6. The luminaire of claim 5, wherein the task lamp housing comprises:
a lamp; and
a lamp cover, wherein illumination produced by the lamp passes through the lamp cover.

7. The luminaire of claim 6, wherein the lamp cover comprises a diffuse material.

8. The luminaire of claim 6, wherein the lamp cover comprises a lens for focusing the illumination produced by the lamp.

9. The luminaire of claim 1, further comprising a switching circuit for controlling an application of a voltage source to said second lamp upon an interruption of power to said first lamp.

10. The luminaire of claim 1, wherein the second lamp is electrically connected to an external emergency power supply system, wherein the external emergency power supply system supplies power to the second lamp upon a power interruption to the first lamp.

11. The luminaire of claim 1, wherein the luminaire housing has a substantially round shape.

12. The luminaire of claim 1, comprising a plurality of second lamps coupled to and extending out from the exterior of the luminaire housing.

13. The luminaire of claim 13, wherein the plurality of second lamps are symmetrically positioned about the exterior of the luminaire housing.

14. A garage luminaire with emergency path of egress lighting comprising:
a luminaire housing comprising an interior and an exterior, wherein the interior comprises a lamp mounting area and a lamp cover;
a first lamp at least partially disposed between the lamp mounting area and the lamp cover;
at least one second lamp coupled to and extending out from the exterior of the luminaire housing, wherein the second lamp is different than the first lamp; and
a switching circuit for controlling the application of a voltage source to the second lamp during an interruption of power to the first lamp.

15. The garage luminaire of claim 14, wherein the second lamp is rotatably coupled to the exterior of the luminaire housing.

16. The garage luminaire of claim 14, further comprising a battery within the luminaire housing for supplying power to the second lamp during an interruption of power to the first lamp.

17. The garage luminaire of claim 14, wherein the second lamp is electrically connected to an external emergency power supply system that supplies power to the second lamp during a power interruption to the first lamp.

18. The garage luminaire of claim 14, wherein each second lamp comprises:
a base plate coupled to the exterior of the luminaire housing;
a task lamp housing comprising the second lamp and a lamp cover, wherein illumination produced by the second lamp passes though the lamp cover; and
wherein the second lamp is electrically coupled to the luminaire housing; and
a longitudinal stem member comprising a first end and a second end, wherein the first end is coupled to the base plate and the second end is coupled to the task lamp housing.

19. The garage luminaire of claim 18, wherein task lamp housing is rotatably coupled to the second end of the stem member.

20. The garage luminaire of claim 14, wherein each second lamp comprises a task lamp housing rotatably coupled to and extending out from the exterior of the luminaire housing, wherein the task lamp housing comprises:
a housing;
the second lamp disposed within the housing; and
a lamp cover disposed substantially along one end of the housing, wherein illumination produced by the second lamp passes though the lamp cover.

21. The garage luminaire of claim 20, wherein the housing for the task lamp housing comprises a substantially cylindrical shape.

22. The garage luminaire of claim 14, wherein each second lamp comprises:
the second lamp; and
a lamp cover coupled to the second lamp and rotatably coupled to and extending out from the luminaire housing, wherein a rotational movement of the lamp cover causes a corresponding rotational movement to the second lamp.

23. The garage luminaire of claim 14, further comprising a plurality of second lamps coupled to and extending out from the exterior of the luminaire housing, wherein the second lamps are disposed substantially symmetrical about the luminaire housing.

24. A garage luminaire with supplemental path of egress lighting comprising:
a luminaire housing comprising an interior and an exterior;
a first lamp coupled within the interior of the luminaire housing, wherein the first lamp comprises the primary lighting source;
a plurality of second lamps coupled to and extending out from the exterior of the luminaire housing, wherein the second lamps comprise an auxiliary path of egress light source;
a switching circuit for controlling the illumination of the plurality of second lamps during an interruption of power to the first lamp; and
a supplemental power source electrically coupled to the plurality of second lamps, wherein the supplemental power source provides electrical power to the plurality of second lamps during an interruption of power to the first lamp.

25. The garage luminaire of claim 24, wherein the supplemental power source is disposed within the luminaire housing.

26. The garage luminaire of claim 24, wherein the supplemental power source is located externally from the luminaire, wherein the supplemental power source comprises an external emergency power supply system that supplies power to the plurality of second lamps during a power interruption to the first lamp.
